(19) United States
(12) Patent Application Publication
(10) Pub. No.: US 2025/0013792 A1
(43) Pub. Date: Jan. 9, 2025

(54) METHOD AND SYSTEM FOR IDENTIFYING UNFOLD LAYOUTS IN B-REP- BASED CAD SHEETMETAL MODELS

(71) Applicant: HCL Technologies Limited, New Delhi (IN)

(72) Inventors: HARI KRISHNAN ELUMALAI, Chennai (IN); RAJESH CHAKRAVARTY, Navi Mumbai (MH)

(21) Appl. No.: 18/367,485

(22) Filed: Sep. 13, 2023

(30) Foreign Application Priority Data
Jul. 5, 2023 (IN) 202311045274

(51) Int. Cl. G06F 30/10

(52) U.S. Cl. CPC G06F 30/10; G06F 2113/24

(57) ABSTRACT

A method and system for identifying an unfold layout for a Boundary Representation (B-rep)-based Computer Aided Design (CAD) sheetmetal model is disclosed. The method includes validating the B-rep based CAD sheetmetal model when at least one planar face is present in the model, and thickness of the B-rep based CAD sheetmetal model is within predefined thickness threshold; determining a plurality of nodes corresponding to a plurality of faces for generating unfold graph; processing one or more plane nodes and subsequently one or more cone nodes for generating first partial unfold layout corresponding to the one or more plane nodes and the one or more cone nodes; processing one or more deform nods for generating second partial unfold layout corresponding to the one or more deform nodes; and joining the first partial unfold layout with the second partial unfold layout for generating the unfold layout for the B-rep-based CAD sheetmetal model.

### TECHNICAL FIELD

Generally, the invention relates to Computer Aided Design (CAD) models. More specifically, the invention relates to method for identifying an unfold layout for a Boundary Representation (B-rep)-based CAD sheetmetal model.

### BACKGROUND

Services of a sheetmetal industry include manufacturing of chassis of automobiles, airplanes, ships, roofing of homes, utensils, ornaments etc. and processes of manufacturing these things involves bending, punching, rolling etc. One notable characteristic of products which are being produced in the sheetmetal industry is the uniformity in thickness of the products. To ensure the uniformity throughout profile of the products, high level of precision in deciding tolerances of tools and dies along a length and a surface area of the metal sheet is required. This is because of high chances of the thickness being changed at places where a bend has been made or a rolling operation has been done. Further, innovations in the IT infrastructure have also contributed to the field of manufacturing by delivering tools such as Computer Aided Design (CAD) software, SolidWorks® and Catia (Dassault Systems), Creo Parametric (PTC), and the like, that can make the research and development process smooth and accurate while saving the time and efforts on a lot of processes. The sheetmetal industry is heavily dependent on the CAD tools for the design and development of various products that are in use.

The CAD software provides a solution by creating Boundary representation (B-rep) models. A B-rep-based CAD model of a sheetmetal model includes faces, edges, and vertices, which are connected to form a topological structure of a part. Data of the part is stored in graphical structure, where each node represents a face, and each link represents an edge. Further, use of such a representation makes it possible to evaluate many properties of the part from its computer model. The properties include a mass, a volume, a moment of inertia and a product of inertia. Additionally, such models enable a computer-based analysis of stress and strains in the part under different loading conditions. The B-rep-based CAD models can also be cut and examined in a manner like an actual part. For these reasons, a B-rep-based CAD model of a part is known as a “Solid” model.

There are various existing systems that effectively process the B-rep-based CAD sheetmetal models for simple structures and parts, for generating unfold layouts. However, generation of an unfold layout for a B-rep-based CAD sheetmetal model with ambiguous regions sometimes provides erroneous results and requires manual intervention. Thus, generating the unfold layout for the B-rep-based CAD sheetmetal model of a part having a complex shape with multiple bends and curves is still a challenge due to the ambiguous regions formed at variety of places.

The present invention is directed to overcome one or more limitations stated above or any other limitations associated with the known arts.

### SUMMARY

In one embodiment, a method identifying an unfold layout for a Boundary Representation (B-rep)-based Computer Aided Design (CAD) sheetmetal model is disclosed. In one embodiment, the method may include validating the B-rep based CAD sheetmetal model when at least one planar face is present in the B-rep based CAD sheetmetal model and thickness of the B-rep based CAD sheetmetal model is within a predefined thickness threshold. The method may further include determining a plurality of nodes corresponding to a plurality of faces of the B-rep based CAD sheetmetal model for generating an unfold graph, upon successful validation. It should be noted that the plurality of nodes may include a root node, one or more plane nodes, one or more cone nodes, and one or more deform nodes. The root node may correspond to a reference planar face selected from the at least one planar face. The method may further include processing the one or more plane nodes and subsequently the one or more cone nodes for generating a first partial unfold layout corresponding to the one or more plane nodes and the one or more cone nodes. The method may further include processing the one or more deform nodes for generating a second partial unfold layout corresponding to the one or more deform nodes. The method may further include joining the first partial unfold layout with the second partial unfold layout for generating the unfold layout for the B-rep-based CAD sheetmetal model.

In another embodiment, a system for identifying an unfold layout for a B-rep-based CAD sheetmetal model is disclosed. The system may include a processor and a memory communicatively coupled to the processor. The memory may store processor instructions, which when executed by the processor, cause the processor to validate the B-rep based CAD sheetmetal model when at least one planar face is present in the B-rep based CAD sheetmetal model and thickness of the B-rep based CAD sheetmetal model is within a predefined thickness threshold. The processor-executable instructions, on execution, may further cause the processor to determine a plurality of nodes corresponding to a plurality of faces of the B-rep based CAD sheetmetal model for generating an unfold graph, upon successful validation. It should be noted that the plurality of nodes may include a root node, one or more plane nodes, one or more cone nodes, and one or more deform nodes. The root node may correspond to a reference planar face selected from the at least one planar face. The processor-executable instructions, on execution, may further cause the processor to process one or more plane nodes and subsequently the one or more cone nodes for generating a first partial unfold layout corresponding to the one or more plane nodes and the one or more cone nodes. The processor-executable instructions, on execution, may further cause the processor to process the one or more deform nodes for generating a second partial unfold layout corresponding to the one or more deform nodes. The processor-executable instructions, on execution, may further cause the processor to join the first partial unfold layout with the second partial unfold layout for generating the unfold layout for the B-rep-based CAD sheetmetal model.

In yet another embodiment, a non-transitory computer-readable medium storing computer-executable instructions for identifying an unfold layout for a B-rep-based CAD sheetmetal model is disclosed. The stored information, when executed by a processor, may cause the processor to perform operations includes validating the B-rep based CAD sheetmetal model when at least one planar face is present in the B-rep based CAD sheetmetal model and thickness of the B-rep based CAD sheetmetal model is within a predefined thickness threshold. The operations may further include determining a plurality of nodes corresponding to a plurality of faces of the B-rep based CAD sheetmetal model for generating an unfold graph upon successful validation. It should be noted that the plurality of nodes may include a root node, one or more plane nodes, one or more cone nodes, and one or more deform nodes. The root node may correspond to a reference planar face selected from the at least one planar face. The operations may further include processing the one or more plane nodes and subsequently the one or more cone nodes for generating a first partial unfold layout corresponding to the one or more plane nodes and the one or more cone nodes. The operations may further include processing the one or more deform nodes for generating a second partial unfold layout corresponding to the one or more deform nodes. The operations may further include joining the first partial unfold layout with the second partial unfold layout for generating the unfold layout for the B-rep-based CAD sheetmetal model.

It is to be understood that both the foregoing general description and the following detailed description are exemplary and explanatory only and are not restrictive of the invention, as claimed.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates a block diagram of a system for identifying an unfold layout for a Boundary Representation (B-rep)-based Computer Aided Design (CAD) sheetmetal model, in accordance with some embodiments of the present disclosure.

FIG. 2 illustrates a flow chart of a method for identifying an unfold layout for a B-rep-based CAD sheetmetal model, in accordance with some embodiments of the present disclosure.

FIG. 3 illustrates a flowchart of a method for validating a B-rep based CAD sheetmetal model, in accordance with some embodiments of the present disclosure.

FIG. 4 is a flowchart of a method for processing plane nodes to generate a first partial layout, in accordance with some embodiments of the present disclosure.

FIG. 5 is a flowchart of a method for processing cone nodes to generate a first partial unfold layout, in accordance with some embodiments of the present disclosure.

FIG. 6 is a flowchart of a method for generating a second partial unfold layout, in accordance with some embodiments of the present disclosure.

FIG. 7 is flow diagram of a detailed method for generating an unfold layout of a B-rep-based CAD sheetmetal model, in accordance with some embodiments of the present disclosure.

FIGS. 8A-8B illustrate top faces and thickness faces of a B-rep-based CAD sheetmetal model, in accordance with some embodiments of the present disclosure.

FIG. 9 illustrates a first partial unfold layout corresponding to plane nodes and cone nodes, in accordance with some embodiments of the present disclosure.

FIGS. 10A-10D illustrate generation of a second partial unfold layout corresponding to deform nodes, in accordance with some embodiments of the present disclosure.

FIG. 11 illustrates a final unfold sheet for each node of a B-rep-based CAD sheetmetal model, in accordance with some embodiments of the present disclosure.

FIG. 12 illustrates a final unfold layout for a B-rep-based CAD sheetmetal model, in accordance with some embodiments of the present disclosure.

FIGS. 13A-13B illustrate an exemplary scenario of unfolding of a B-rep-based CAD sheetmetal model, in accordance with some embodiments of the present disclosure.

FIGS. 14A-14C illustrate an exemplary scenario of generating an unfold graph and unfold layout for a B-rep-based CAD sheetmetal model, in accordance with some embodiments of the present disclosure.

FIGS. 15A-15B illustrate an exemplary scenario of generating an unfold graph for a B-rep-based CAD sheetmetal model with an ambiguity, in accordance with some embodiments of the present disclosure.

FIG. 16 is a block diagram of an exemplary computer system for implementing embodiments consistent with the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

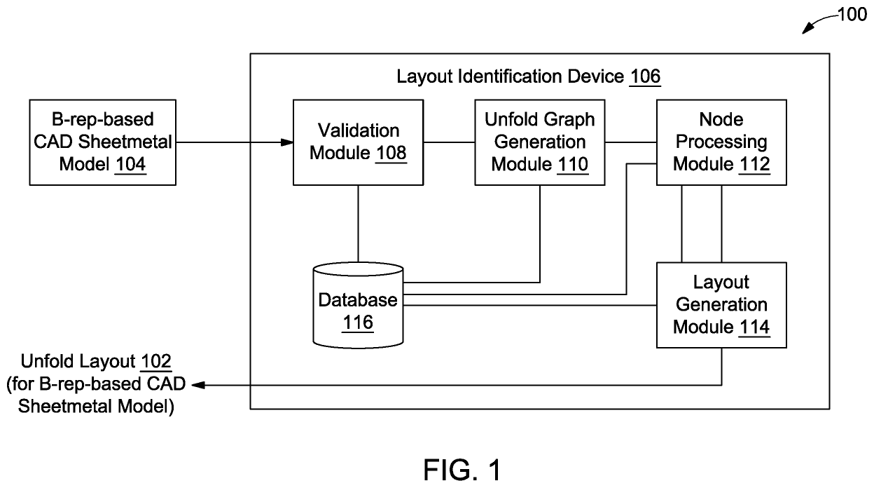

Referring now to FIG. 1, a block diagram of a system 100 for identifying an unfold layout 102 for a Boundary Representation (B-rep)-based Computer Aided Design (CAD) sheetmetal model 104 is illustrated, in accordance with some embodiments. The system 100 may include a layout identification device 106. The layout identification device 106 may perform various operations for identifying unfold layouts. Further, to perform the operations, the layout identification device 106 may include various modules including a validation module 108, an unfold graph generation module 110, a node processing module 112, and a layout generation module 114. The layout identification device 106 may further include a database 116 to store various data and intermediate results generated by the modules 108-114.

In one embodiment, the validation module 108 may be configured to receive the B-rep-based CAD sheetmetal model 104. Further, in another embodiment, the validation module 108 may be configured to validate the B-rep-based CAD sheetmetal model 104. The B-rep-based CAD sheetmetal model 104 may be validated based on presence of a planar face and thickness of the B-rep-based CAD sheetmetal model 104. In one embodiment, the B-rep-based CAD sheetmetal model 104 may have only one planar face. In another embodiment, the B-rep-based CAD sheetmetal model 104 may have more than one planar face. It should be noted that for the B-rep-based CAD sheetmetal model 104 to be validated, at least one planar face should be present in the B-rep-based CAD sheetmetal model 104, and thickness of the B-rep-based CAD sheetmetal model 104 should be within a predefined thickness threshold. In some embodiments, a reference planar face may be selected from the planar faces when there is more than one planar faces are present. In case of only one planar face, that planar face may be considered as the reference planar face. Further, in some embodiments, the thickness of the B-rep-based CAD sheetmetal model 104 may be determined based on the reference planar face.

It should be noted that a planar face with largest area may be selected as the reference planar face. Further, based on the reference planar face, the thickness of a body associated with the B-rep-based CAD sheetmetal model 104 may be computed by finding an opposite face of the reference planar face through an intelligent heuristics. In case the computed thickness is out of the predefined thickness threshold, then the process of unfolding the B-rep-based CAD sheetmetal model 104 may stop. Otherwise, when the computed thickness is within the predefined thickness threshold, then the process may continue. The validation module 108 may be communicatively coupled to the unfold graph generation module 110 for transmitting the validated B-rep-based CAD sheetmetal model 104 to the unfold graph generation module 110.

The unfold graph generation module 110 may be configured to determine a plurality of nodes corresponding to a plurality of faces of the B-rep-based CAD sheetmetal model 104, to generate an unfold graph. The plurality of nodes may include a root node, one or more plane nodes, one or more cone nodes, and one or more deform nodes. It may be noted that the root node may correspond to the reference planar face selected from the planar faces. The plurality of nodes may be interconnected through a plurality of links, in the unfold graph. Here, the plurality of links may correspond to a plurality of edges connecting the plurality of faces in the B-rep-based CAD sheetmetal model 104.

The unfold graph may be generated by propagating from the reference planar face. Top faces are only considered by propagating through the faces connected with the reference planar face. The propagation stops at thickness faces of the B-rep-based CAD sheetmetal model 104 which may be identified using the internal heuristics. In some embodiments, transformations and unfold paths corresponding to the one or more plane nodes and transformations and unfold paths corresponding to the one or more cone nodes may be computed. It should be noted that the transformations corresponding to the one or more plane nodes are computed based on transformations of corresponding parent nodes. Further, the unfold graph generation module 110 may be operatively coupled to the node processing module 112 to transmit the unfold graph to the node processing module 112.

In some embodiments, the node processing module 112 may be configured for processing the one or more plane nodes. Further, outer boundaries of one or more planar faces may be determined. The one or more planar faces may correspond to the one or more plane nodes. The computed transformations and unfold paths corresponding to the one or more plane nodes may be applied to the one or more planar faces. In some embodiments, the node processing module 112 may be configured for processing the one or more cone nodes. Further, uniform points on edges associated with one or more conical faces and cylindrical faces may be determined by discretizing edges. The one or more conical faces and cylindrical faces may correspond to the one or more cone nodes. The transformations and unfold paths corresponding to the one or more cone nodes computed during generation of the unfold graph may be applied to the uniform points for computing transform points. The transformations corresponding to the cone nodes are computed based on a plurality of predefined parameters of the one or more conical faces and cylindrical faces and transformations of corresponding parent nodes. The plurality of parameters may include a bend angle and a radius. Further, outer boundary curve segments of the one or more conical faces and cylindrical faces may be created based on the transform points. It should be noted that the one or more plane nodes and the one or more cone nodes may be processed to generate a first partial unfold layout corresponding to the one or more plane nodes and the one or more cone nodes.

In some other embodiments, the node processing module 112 may be configured for processing the one or more deform nodes. The one or more deform nodes may be processed to generate a second partial unfold layout corresponding to the one or more deform nodes. For each of the one or more deform nodes, edges of a deform face corresponding to a deform node of the one or more deform nodes may be identified. Further, for each of the one or more deform nodes, one or more common edges between the edges of the deform face and edges of adjacent parent faces of the deform face may be identified. Based on the one or more common edges, an unfold path corresponding to the deform face may be computed. Further, presence of curve segments may be determined based on unfold layouts created for adjacent/neighboring faces corresponding to adjacent/neighboring nodes. When the curve segments are present, a copy of the curve segments may be created. Alternatively, when the curve segments are absent, uniform points on the edges of the deform face may be determined for generating discretized edges. Further, a plurality of unfold points corresponding to the uniform points may be determined based on a proportional relationship between the edges of the deform face and corresponding edges of the edges of adjacent parent faces of the deform face in the first partial unfold layout. A plurality of transformed unfold points corresponding to the plurality of unfold points may be calculated based on a translation direction computed for each of the plurality of unfold points, and a length between each of the uniform points on an edge of the deform face and a corresponding uniform point on another edge of the deform face located at shortest distance. Further, an estimated curve segment may be computed through the plurality of transformed unfold points. The second partial unfold layout may be generated using the curve segments. The node processing module 112 may be communicatively coupled to the layout generation module 114.

The layout generation module 114 may be configured for joining the first partial unfold layout with the second partial unfold layout. As a result, the unfold layout 102 for the B-rep-based CAD sheetmetal model 104 may be generated.

It should be noted that the system 100 and associated layout identification device 106 may be implemented in programmable hardware devices such as programmable gate arrays, programmable array logic, programmable logic devices, or the like. Alternatively, the system 100 and the layout identification device 106 may be implemented in software for execution by various types of processors. An identified engine/module of executable code may, for instance, include one or more physical or logical blocks of computer instructions which may, for instance, be organized as an object, module, procedure, function, or other construct. Nevertheless, the executables of an identified engine/module need not be physically located together but may include disparate instructions stored in different locations which, when joined logically together, comprise the identified engine/module and achieve the stated purpose of the identified engine/module. Indeed, an engine or a module of executable code may be a single instruction, or many instructions, and may even be distributed over several different code segments, among different applications, and across several memory devices.

As will be appreciated by one skilled in the art, a variety of processes may be employed for identifying an unfold layout 102. For example, the exemplary system 100 and the layout identification device 106 may identify the unfold layout 102 for the B-rep-based CAD sheetmetal model 104, by the process discussed herein. In particular, as will be appreciated by those of ordinary skill in the art, control logic and/or automated routines for performing the techniques and steps described herein may be implemented by the system 100 and the layout identification device 106 either by hardware, software, or combinations of hardware and software. For example, suitable code may be accessed and executed by the processor (not shown in FIG. 1) in the layout identification device 106 to perform some or all of the techniques described herein. Similarly, application specific integrated circuits (ASICs) configured to perform some or all the processes described herein may be included in the processor in the layout identification device 106.

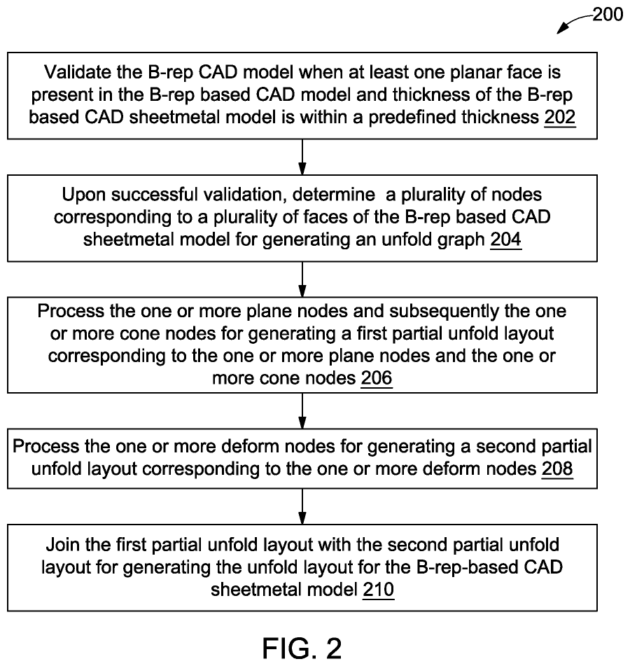

Referring to FIG. 2, a flowchart 200 of a method for identifying an unfold layout (for example, the unfold layout 102) for a B-rep-based CAD sheetmetal model (for example, the B-rep-based CAD sheetmetal model 104) is depicted, in accordance with an embodiment of the present disclosure. FIG. 2 is explained in conjunction with FIG. 1. Each step of the flowchart 200 is performed by a layout identification device (such as the layout identification device 106).

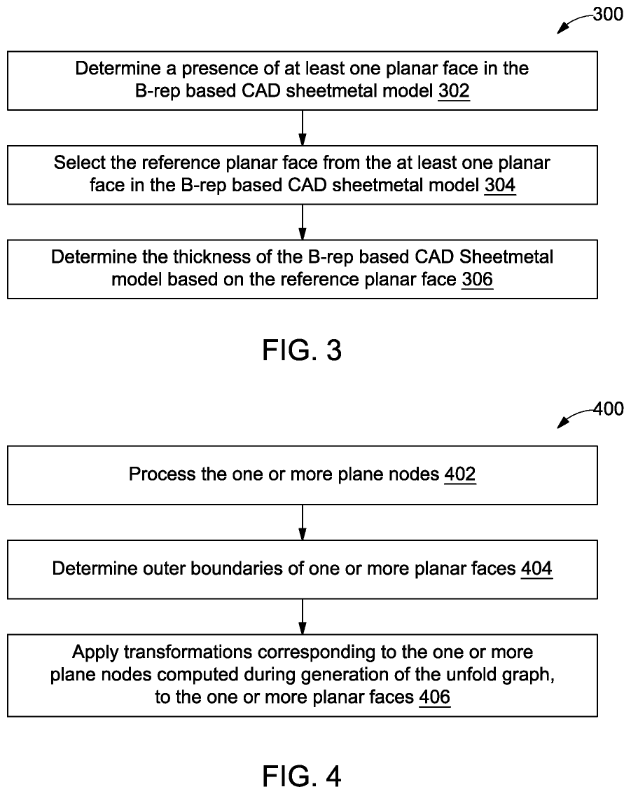

At step 202, the B-rep based CAD sheetmetal model may be validated. A criterion for validation includes presence of at least one planar face in the B-rep based CAD sheetmetal model and thickness of the B-rep based CAD sheetmetal model should be within a predefined thickness threshold. This step may be performed using a validation module (such as the validation module 108). Thickness determination is further explained in detail in conjunction with FIG. 3.

Upon successful validation, at step 204, a plurality of nodes corresponding to a plurality of faces of the B-rep based CAD sheetmetal model may be determined. As a result, an unfold graph may be generated. This step may be performed using an unfold graph generation module (such as the unfold graph generation module). It should be noted that the plurality of nodes may include a root node, one or more plane nodes, one or more cone nodes, and one or more deform nodes. The root node may correspond to a reference planar face selected from the at least one planar face, and the one or more plane nodes may correspond to one or more planar faces. Further, the one or more cone nodes may correspond to one or more conical faces and cylindrical faces, and the one or more deform nodes may correspond to one or more deform faces. The plurality of nodes may be interconnected through a plurality of links, in the unfold graph. The plurality of links may correspond to a plurality of edges connecting the plurality of faces in the B-rep-based CAD sheetmetal model.

At step 206, the one or more plane nodes and subsequently the one or more cone nodes may be processed using a node processing module (such as the node processing module 112). As a result, a first partial unfold layout corresponding to the one or more plane nodes and the one or more cone nodes may be generated. Thereafter, at step 208, the one or more deform nodes may be processed for generating a second partial unfold layout corresponding to the one or more deform nodes using the node processing module. The processing of nodes and generation of the first partial unfold layout and the second partial unfold layout is further explained in detail in conjunction with FIGS. 4-6.

At step 210, the first partial unfold layout may be joined with the second partial unfold layout to generate the unfold layout for the B-rep-based CAD sheetmetal model. This step is performed using a layout generation module (such as the layout generation module 114).

Referring now to FIG. 3, a flowchart 300 of a method for validating the B-rep based CAD sheetmetal model is depicted, in accordance with an embodiment of the present disclosure. FIG. 3 is explained in conjunction with FIGS. 1-2. Each step of the flowchart 300 is executed via a validation module (such as the validation module 108). At step 302, a presence of at least one planar face in the B-rep based CAD sheetmetal model may be determined. It should be noted that for validating the B-rep-based CAD sheetmetal model, there should be the at least one planar face.

At step 304, the reference planar face may be selected from the at least one planar face in the B-rep based CAD sheetmetal model. In other words, if the B-rep-based CAD sheetmetal model doesn't include a planar face, the B-rep-based CAD sheetmetal model may be considered as an invalid model for unfolding process. When there is only one planar face in the B-rep-based CAD sheetmetal model, that one planar face may be considered as the reference planar face. Further, when there is more than one planar face in the B-rep-based CAD sheetmetal model, then the reference planar face may be selected from the present planar faces. For example, consider that the B-rep-based CAD sheetmetal model includes five planar faces. In that case, one planar face with the largest area may be selected from the five planar faces as the reference planar face.

Once the reference planar face is selected, thereafter, at step 306, the thickness of the B-rep based CAD sheetmetal model may be determined based on the reference planar face. It should be noted that for the B-rep-based CAD sheetmetal model to be validated, the at least one planar face should be present in the B-rep-based CAD sheetmetal model, and the thickness of the B-rep based CAD sheetmetal model should be within a predefined thickness threshold. The thickness of a the B-rep-based CAD sheetmetal model may be computed by finding an opposite face of the reference planar face through an intelligent heuristics. In case the computed thickness is out of the predefined thickness threshold, then the process of unfolding the B-rep-based CAD sheetmetal model may stop. Otherwise, when the computed thickness is within the predefined thickness threshold, then the B-rep-based CAD sheetmetal model may be considered as a valid model for unfolding process.

Referring now to FIG. 4, a flowchart 400 of a method for processing the one or more plane nodes to generate a first partial unfold layout is depicted, in accordance with an embodiment of the present disclosure. FIG. 4 is explained in conjunction with FIGS. 1-3. Each step of the flowchart 400 is executed via a node processing module (such as the node processing module 112).

At step 402, the one or more plane nodes may be processed. At step 404, outer boundaries of one or more planar faces may be determined. It should be noted that the one or more planar faces may correspond to the one or more plane nodes. Thereafter, at step 406, transformations corresponding to the one or more plane nodes computed during generation of the unfold graph may be applied to the one or more planar faces. The transformations corresponding to the one or more plane nodes may have been computed based on transformations of corresponding parent nodes.

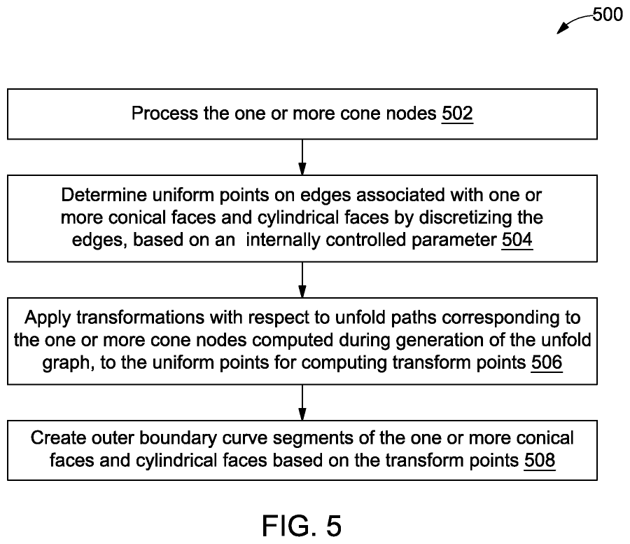

Referring now to FIG. 5, a flowchart 500 of a method for processing the one or more cone nodes to generate a first partial unfold layout is depicted, in accordance with an embodiment of the present disclosure. FIG. 5 is explained in conjunction with FIGS. 1-4. Each step of the flowchart 500 is executed via a node processing module (such as the node processing module 112). At step 502, the one or more cone nodes may be processed.

At step 504, uniform points may be determined on edges associated with one or more conical faces and cylindrical faces. The uniform points may be determined by discretizing the edges based on an internally controlled parameter. It should be noted that the one or more conical faces and cylindrical faces may correspond to the one or more cone nodes. At step 506, transformations with respect to unfold paths corresponding to the one or more cone nodes computed during generation of the unfold graph may be applied to the uniform points for computing transform points. The transformations corresponding to the cone nodes may be computed based on a plurality of predefined parameters of the one or more conical faces and cylindrical faces and transformations of corresponding parent nodes. The plurality of parameters may include a bend angle and a radius.

Thereafter, at step 508, outer boundary curve segments of the one or more conical faces and cylindrical faces may be created based on the transform points.

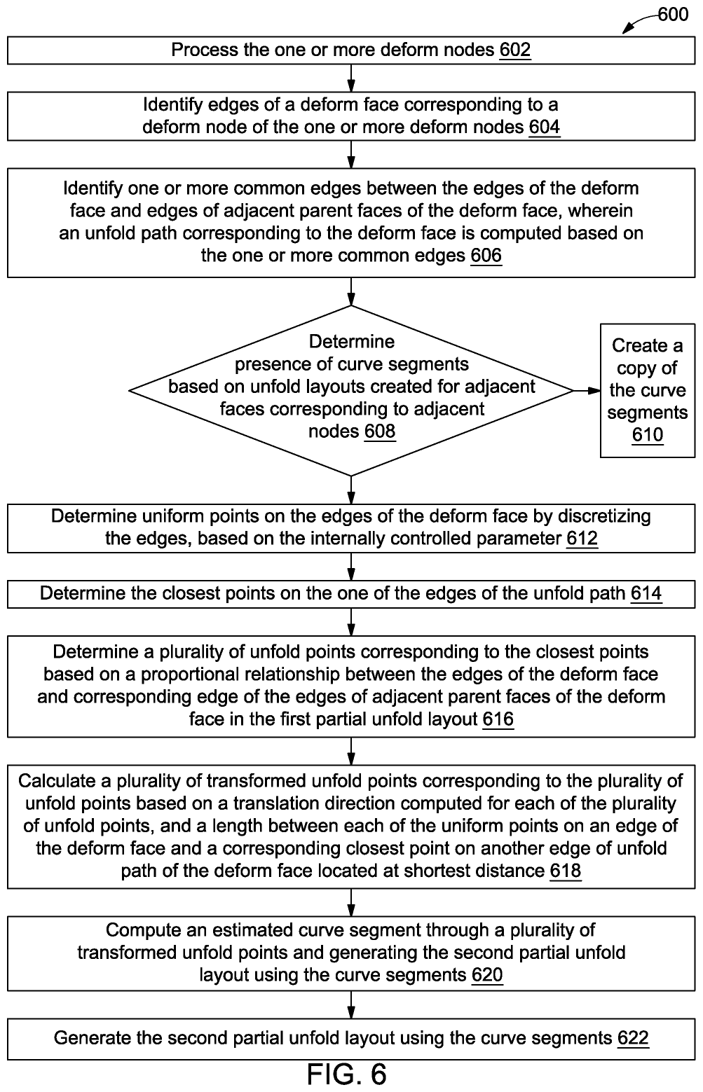

Referring now to FIG. 6, a flowchart 600 of a method for generating a second partial unfold layout is depicted, in accordance with an embodiment of the present disclosure. FIG. 6 is explained in conjunction with FIGS. 1-5. Each step of the flowchart 600 is executed via a node processing module (such as the node processing module 112).

At step 602, the one or more deform nodes may be processed. At step 604, edges of a deform face corresponding to a deform node of the one or more deform nodes may be identified. At the step 606, one or more common edges between the edges of the deform face and edges of adjacent parent faces of the deform face may be identified. It should be noted that an unfold path corresponding to the deform face may be computed based on the one or more common edges.

Further, at step 608, presence of curve segments based on the unfold layouts created for adjacent/neighbouring faces corresponding to adjacent/neighbouring nodes may be determined. In case the curve segments are present, at step 610, a copy of the curve segments may be created. Otherwise, when the curve segments are absent, at step 612, uniform points on the edges of the deform face may be determined by discretizing the edges, based on the internally controlled parameter. At step 614, the closest points on the one of the edges of the unfold path may be determined.

Thereafter, at step 616, a plurality of unfold points corresponding to the closest points may be determined based on a proportional relationship between the edges of the deform face and corresponding edge of the edges of adjacent parent faces of the deform face in the first partial unfold layout. Further at step 618, a plurality of transformed unfold points corresponding to the plurality of unfold points based on a translation direction computed for each of the plurality of unfold points, and a length between each of the uniform points on an edge of the deform face and a corresponding closest point on another edge of unfold path of the deform face located at shortest distance may be calculated. Further, at the step 620, an estimated curve segment may be computed through a plurality of transformed unfold points. Thereafter, at step 622, the second partial unfold layout may be generated using the curve segments.

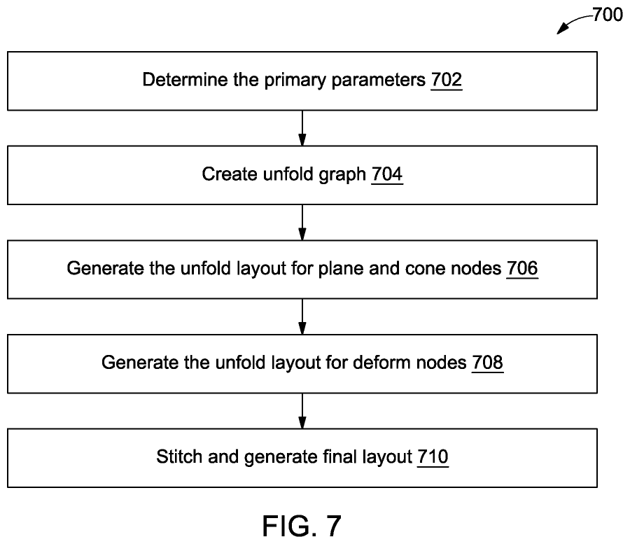

Referring now to FIG. 7, a flowchart 700 of a detailed method for generating an unfold layout of a B-rep-based CAD sheetmetal model is depicted, in accordance with an embodiment of the present disclosure. FIG. 7 is explained in conjunction with FIGS. 1-6. Each step of the flowchart 700 is executed via a layout identification device (such as the layout identification device 106).

At step 702, primary parameters associated with the B-rep-based CAD sheetmetal model may be determined. The primary parameters may include a reference planar face and thickness of the the B-rep based CAD sheetmetal model. First, a reference planar face may be identified based on area of planar faces. By way of an example, when there is only one planar face in the B-rep based CAD sheetmetal model, the planar face may automatically be determined as the reference planar face. By way of another example, when there are two planar faces or more than two planar faces, in that case, an area of each of the two or more planar faces may be computed. Further, a planar face with the largest area from the two or more planar faces may be determined as the reference planar face. When there is no planar face in the B-rep based CAD sheetmetal model, the B-rep based CAD sheetmetal model may be invalidated for further processing.

Once the reference planar face is determined, thickness of the B-rep based CAD sheetmetal model may be computed based on the reference planar face. The thickness may be computed by finding the opposite face of the reference planar face based on intelligent heuristics. This step may be performed for validation of the B-rep based CAD sheetmetal model using a validation module (such as the validation module 108) as described in FIG. 1.

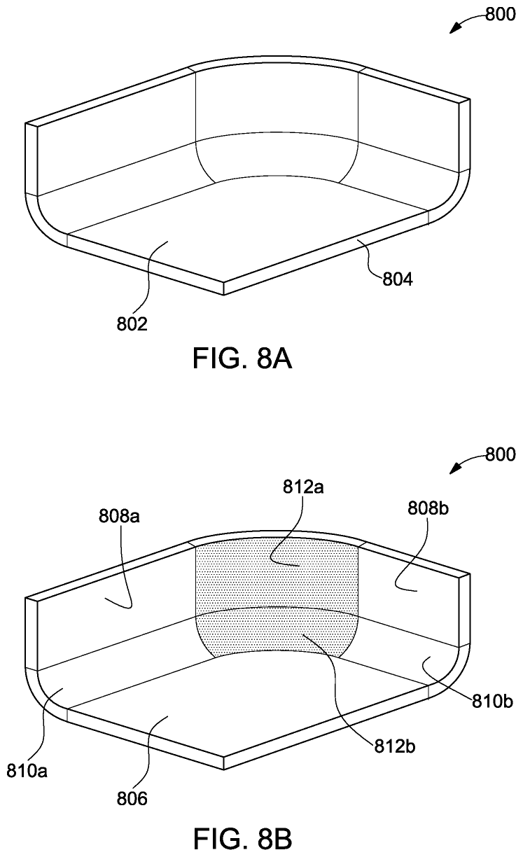

Further, at step 704, an unfold graph may be created for the B-rep based CAD sheetmetal model after satisfying the primary parameters at the step 702, using an unfold graph generation module (such as the unfold graph generation module 110). The process of graph generation requires generation of nodes based on the identification of plurality of faces in the B-rep based CAD sheetmetal model. The unfold graph may be generated by propagating from the reference planar face. Top faces may only be considered by propagating through the faces connected with the reference planar face. Propagation stops at thickness faces of the B-rep-based CAD sheetmetal model which may be identified using internal heuristics. In FIG. 8A, top faces 802 and thickness faces 804 are illustrated in a B-rep-based CAD sheetmetal model 800. Further, the unfold graph may include a root node, one or more cone nodes, one or more plane nodes, and one or more deform node. The root node may be created using the reference planar face. The one or more cone nodes may be created using faces of cylindrical and conical geometry type. The one or more plane nodes may be created using faces of planar geometry type.

The one or more deform nodes for the corresponding faces may be ambiguous regions in the B-rep-based CAD sheetmetal model. These nodes may be created under conditions including when geometry type of a face is other than a planar, a cylindrical or a conical type. The conditions may further include when a plane node or cone node is already existing in the unfold graph for a face, then the face is already associated with a parent. This may lead to ambiguity in the unfold graph. Such a plane node or cone node may be converted into a deform node. Further, the conditions may include when a node of a parent face is a deform node. In FIG. 8B, a face 806 (i.e., a reference planar face) corresponding to a root node, faces 808a, 808b corresponding to plane nodes, faces 810a, 810b corresponding to cone nodes, faces 812a, 812b corresponding to deform nodes are illustrated in the B-rep-based CAD sheetmetal model 800.

The root node corresponding to a face (such as the face 806) may be created using the reference planar face. Then this root node may act as parent node. Further, adjacent faces (for example, the adjacent faces 810a, 810b, 812b) of a parent node (i.e., the root node) may be collected, and child nodes may be created using the adjacent faces (for example, the adjacent faces 810a, 810b, 812b). Again, these child nodes in turn acts as parent nodes and its adjacent faces (for example, the adjacent faces 808a, 808b, 812a) may be collected to create further child nodes. This process continues till all the top faces (for example, the top faces 802) in a B-rep-based CAD sheet metal model (for example, the B-rep-based CAD sheet metal model 800) are added as node in the unfold graph. Before creating a node for a face, the face may be checked for its node existence in the graph. If the node does not exist in the graph, then node may be created and added to the graph according to the face type and conditions for the deform node. It should be noted that, for a cone node, transformations may be computed using a bend angle and a radius of cylindrical or conical face associated with the node, and transformations of a parent node, during generation of the unfold graph. Further, for a plane node, transformations computed for the parent node is set as its transformation. Unfold path may be a path about which the face may be unfold. The unfold path for the plane or the cone node may be shared edges between faces of respective nodes and faces of parent nodes. The transformations and unfold path information of the plane node and the cone node may be used while unfolding the graph. Also, it should be noted, for a deform node, transformations and unfold path may not be computed during graph generation due to ambiguity in unfolding. It is computed only during the generation of unfold layout.

At step 706, an unfold layout for the plane nodes and cone nodes may be generated. The unfold layout may correspond the first partial unfold layout. While generating an unfold sheet for each node, a relationship between a face edge and its corresponding curve segment used to create the unfold layout may be maintained in an associative container in a form of Key-Value pairs. Also, the unfold sheet created for each node may be associated to a respective node. The one or more plane nodes in the unfold graph may be processed first to create a corresponding unfold layout. For a plane node, an unfold planar sheet (the unfold layout) may be created using outer boundary of a corresponding planar face associated with the plane node. Thereafter, the transformations computed during generation of the unfold graph may be applied to the unfold sheet. The created unfold sheet may be associated to a respective node.

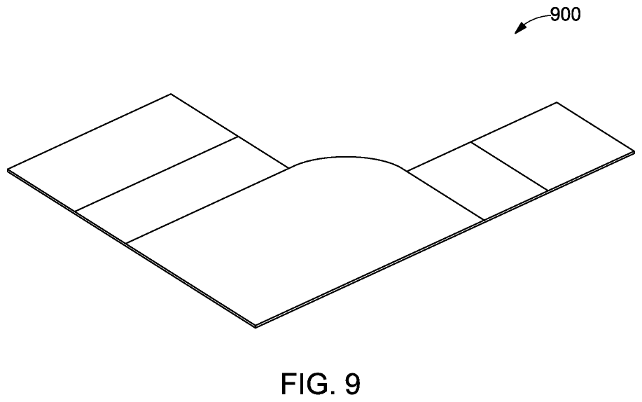

The one or more cone nodes in the unfold graph may be processed next to create the corresponding unfold layout (the first partial unfold layout). Edges of a conical or a cylindrical face attached to a corresponding cone node may be collected. Each edge may be discretized into uniform points using an internally controlled parameter. Then the transformed points may be computed by applying the transformations on the discretized points. Referring to FIG. 9, a first partial unfold layout 900 corresponding to plane nodes and cone nodes (associated with faces 808a, 808b, 810a, and 810b) of the B-rep-based CAD sheetmetal model 800 is illustrated.

At step 708, an unfold layout (i.e., the second partial unfold layout) may be generate for the deform nodes. For each of the one or more nodes, edges of a face attached to a deform node may collected. Further, shared edges between the face of the deform node and faces of adjacent parent nodes may be found. The shared edges may act as unfold path edges for the deform node. Using face edge, corresponding curve segment may be searched in the Key-Value pairs of the associative container. If the curve segment is found, then a copy of the curve segment may be created. Alternatively, if the curve segment is not found, then face edge is discretized into uniform points using the internally controlled parameter.

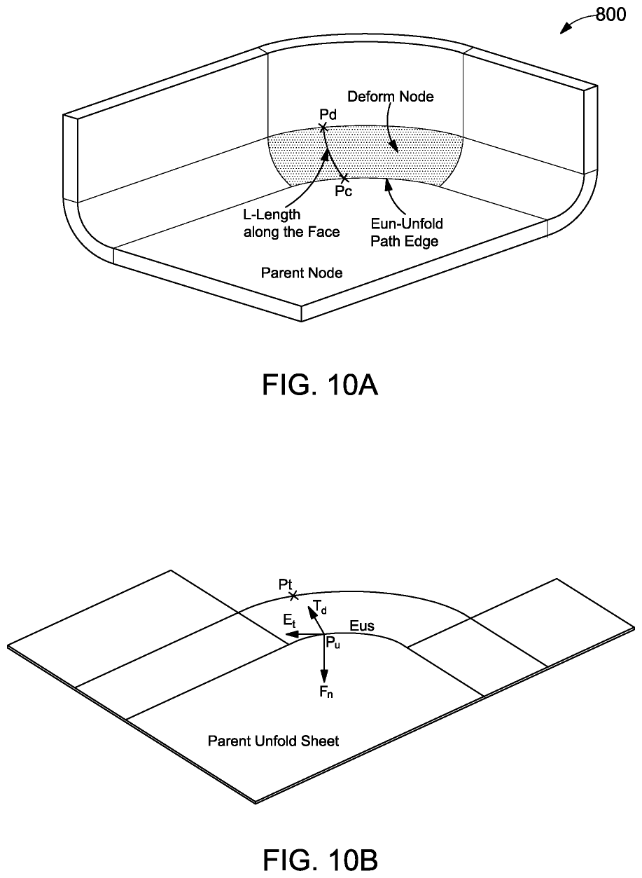

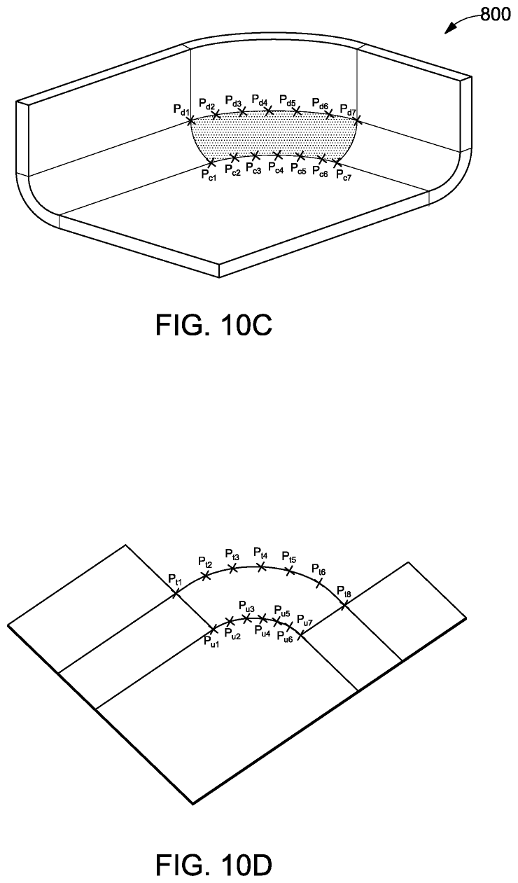

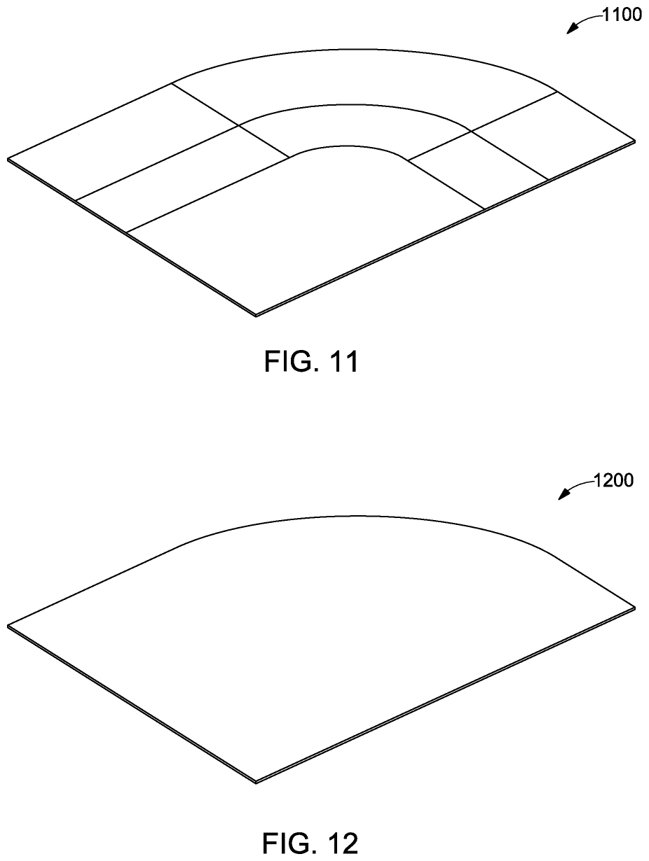

Referring now to FIGS. 10A-10D, generation of a second partial unfold layout corresponding to deform nodes in the B-rep-based CAD sheetmetal model 800 is illustrated. It should be noted that for each discretized point (for example, a point P_{d}) on the face edge, a closest position (for example, a point P_{c}) and the corresponding edge (for example, the edge Eᵤₙ) may be found out using unfold path edges. Length (for example, a length L) along the deform node face between the two points (i.e., the points P_{d} and P_{c}) may be calculated. Then the associated unfold sheet (i.e., the unfold layout) corresponding to the parent node of the corresponding edge (i.e., the edge Eᵤₙ) may be retrieved. Further, using proportion relationship between the face edge (i.e., the edge Eᵤₙ) and an unfold sheet edge (for example, an edge Eᵤₛ), a position (i.e., a position Pᵤ) as illustrated in FIG. 10B, on a parent unfold sheet may be computed corresponding to the position (i.e., the position Pᵤ) on the B-rep-based CAD sheetmetal model 800. Further, a translation direction (i.e., the direction ‘T_{d}’) at position ‘Pᵤ’ is computed using an edge tangent (i.e., an edge tangent Eₜ) and a face normal (i.e., a face normal Fₙ) at the position Pᵤ. Using the length and the translation direction, a transformed position (i.e., a transformed position Pₜ) may be computed for the position Pu. Using a set of ‘Pₜ’ points computed for discretized points of the face edge, a curve segment may be created, as illustrated in FIGS. 10C-10D. Then a final unfold sheet 1100 may be created, for each node, using the all the boundary curve segments, and the unfold sheet may be associated to the respective node, as illustrated in FIG. 11.

At step 710, a final unfold layout may be generated for the B-rep-based CAD sheetmetal model by stitching the first partial unfold layout and the second partial unfold layout. All the unbend sheets attached to nodes may be collected and stitched using the internal heuristics. Outer boundary of the stitched sheet may be the final unfold layout of the B-rep-based CAD sheetmetal model. In FIG. 12, a final unfold layout 1200 for the B-rep-based CAD sheetmetal model 800 is illustrated.

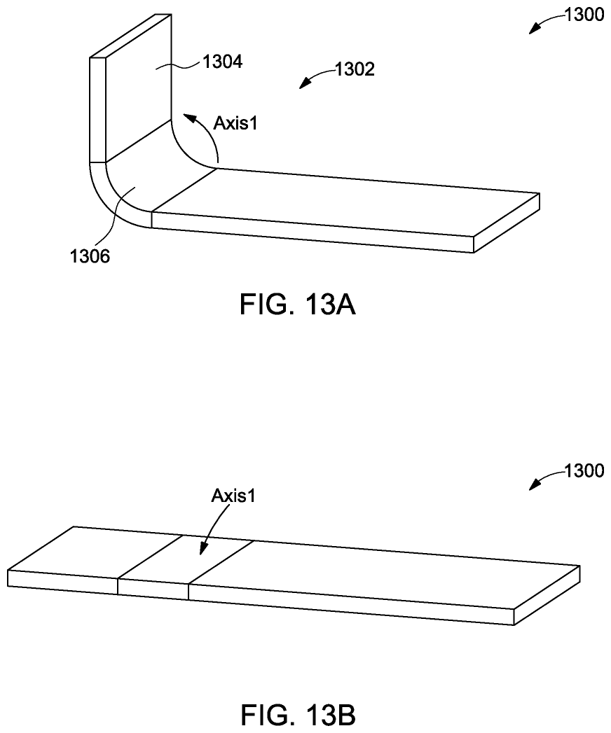

Referring now to FIGS. 13A-13B, an exemplary scenario 1300 of unfolding of a B-rep-based CAD sheetmetal model 1302 is illustrated, in accordance with an embodiment of the present invention. A typical B-rep-based CAD sheetmetal model includes walls, bends, and other features. The B-rep-based CAD sheetmetal model 1302 includes a wall 1304, and a bend 1306. Unfolding the B-rep-based CAD sheetmetal model 1302 involves rotating the wall 1304 feature (a planar face) about the bend 1306 (a cylindrical/conical face) in an opposite direction (unbend) as shown in the FIG. 13B.

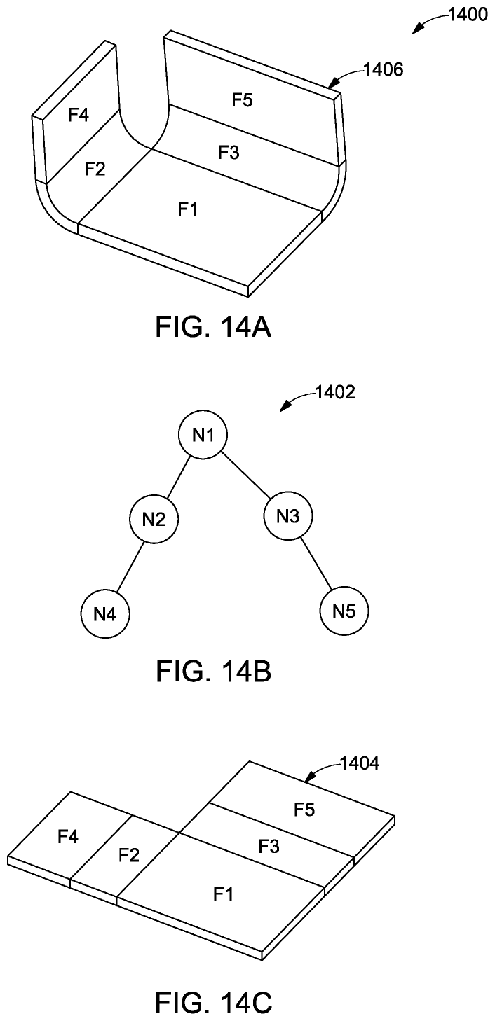

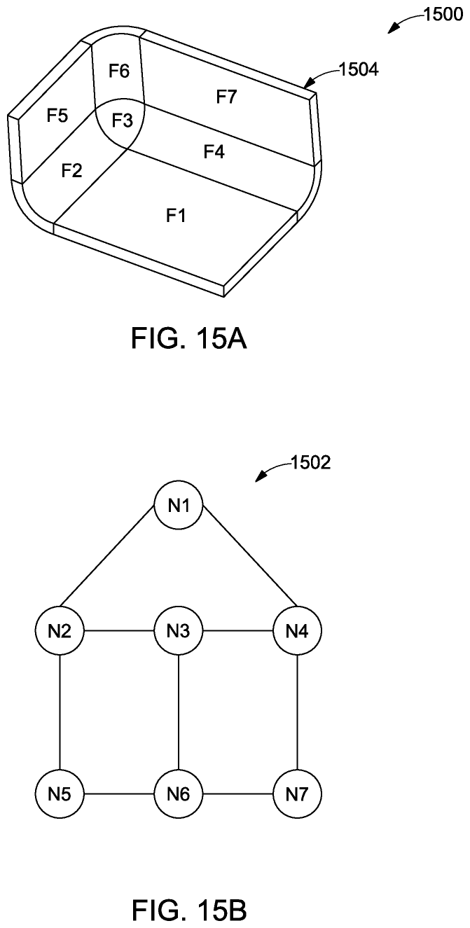

Referring now to FIGS. 14A-14C, an exemplary scenario 1400 generating an unfold graph 1402 and unfold layout 1404 for a B-rep-based CAD sheetmetal model 1406 is illustrated, in accordance with an embodiment of the present invention. The B-rep-based CAD sheetmetal model 1406 includes faces ‘F1’, ‘F2’, ‘F3’, ‘F4’, and ‘F5’. The face ‘F1’ may be determined as reference planar face with the largest area. Thus, to generate the unfold graph 1402, a node ‘N1’ may be created as a root node.

Further, the Face ‘F1’ shares edges with the faces ‘F2’ and ‘F3’. Thus, corresponding nodes ‘N2’ and ‘N3’ may be created as child nodes for the node ‘N1’. Further, the face ‘F2’ shares an edge with the face ‘F4’, and the face ‘F3’ shares an edge with the face ‘F5’. Thus, a node ‘N4’ may be created as a child node for the node ‘N2’. A node ‘N5’ may be created as a child node for the node ‘N3’. FIG. 14C illustrates the unfold layout 1404 generated based on the unfold graph 1402 for the B-rep-based CAD sheetmetal model 1406. The unfolding process may be modelled as an undirected unfold graph where each node (corresponding to a face) has a single parent node (a corresponding face) except the root node (i.e., the reference planar face). The unfold graph may be in a form of a tree for a completely non-foldable model (i.e., all faces have one unique direction of unbend) as shown in FIGS. 14A-14B. Generation of an unfold layout for a B-rep-based CAD sheetmetal model has already been explained in detail in conjunction with FIGS. 1-13.

Referring now to FIGS. 15A-15B, an exemplary scenario 1500 generating an unfold graph 1502 for a B-rep-based CAD sheetmetal model 1504 with an ambiguity is illustrated, in accordance with an embodiment of the present invention. Whenever the unfolding operation is not well defined for some regions, then there is an ambiguity to unfold in those regions. It means a face has two or more directions about which it may be unfold. It is those regions where the unfolding process resulting into the face (material) getting distorted/deformed. FIG. 15A illustrates the B-rep-based CAD sheetmetal model 1504 with such ambiguity for unfolding. The B-rep-based CAD sheetmetal model 1504 includes faces ‘F1’, ‘F2’, ‘F3’, ‘F4’, ‘F5’, ‘F6’, and ‘F7’.

The face ‘F1’ may be determined as reference planar face with the largest area. Thus, to generate the unfold graph 1502, a node ‘N1’ may be created as a root node. Further, the face ‘F1’ shares edges with the face ‘F2’ and ‘F4’. Thus, corresponding child nodes ‘N2’ and ‘N4’ may be created. The node ‘N1’ may act as parent node for the nodes ‘N2’ and ‘N4’. Now, the face ‘F2’ shares edges with the faces ‘F3’ and ‘F5’, and the face ‘F4’ shares edges with the face ‘F3’ and the face ‘F7’. Thus, the child nodes ‘N3’, ‘N5’, and ‘N7’ may be created. The node ‘N2’ acts as a parent node for the nodes ‘N5’ and the node ‘N3’. The node ‘N4’ acts as a parent node for the nodes ‘N3’ and ‘N7’. Further, the faces ‘F3’, ‘F5’, ‘F7’ share edges with the face ‘F6’. Thus, a corresponding child node ‘N6’ may be created. The nodes ‘N5’, ‘N7’, ‘N3’ act parent nodes for the node ‘N6’. Here, the faces ‘F6’ and ‘F3’ are having ambiguity in unfolding as it has more than one parents.

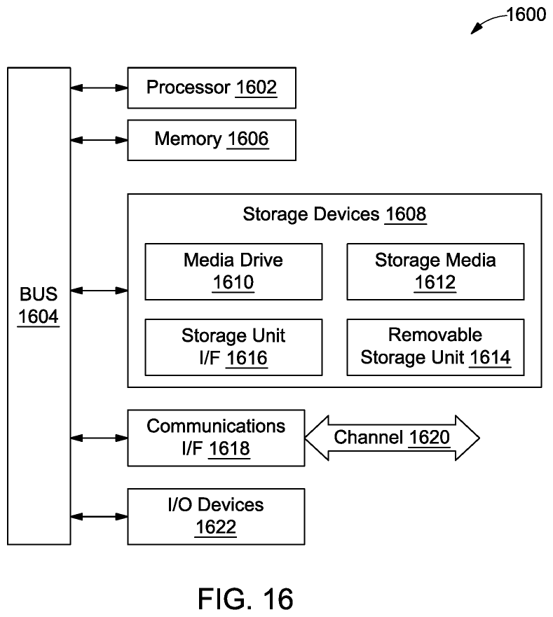

The disclosed methods and systems may be implemented on a conventional or a general-purpose computer system, such as a personal computer (PC) or server computer. Referring now to FIG. 16, an exemplary computing system 1600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 1600 may represent, for example, a user device such as a desktop, a laptop, a mobile phone, personal entertainment device, DVR, and so on, or any other type of special or general-purpose computing device as may be desirable or appropriate for a given application or environment. The computing system 1600 may include one or more processors, such as a processor 1602 that may be implemented using a general or special purpose processing engine such as, for example, a microprocessor, microcontroller or other control logic. In this example, the processor 1602 is connected to a bus 1604 or other communication medium. In some embodiments, the processor 1602 may be an AI processor, which may be implemented as a Tensor Processing Unit (TPU), or a graphical processor unit, or a custom programmable solution Field-Programmable Gate Array (FPGA).

The computing system 1600 may also include a memory 1606 (main memory), for example, Random Access Memory (RAM) or other dynamic memory, for storing information and instructions to be executed by the processor 1602. The memory 1606 also may be used for storing temporary variables or other intermediate information during execution of instructions to be executed by the processor 1602. The computing system 1600 may likewise include a read only memory (“ROM”) or other static storage device coupled to bus 1604 for storing static information and instructions for the processor 1602.

The computing system 1600 may also include a storage device 1608, which may include, for example, a media drives 1610 and a removable storage interface. The media drive 1610 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 1612 may include, for example, a hard disk, magnetic tape, flash drive, or other fixed or removable medium that is read by and written to by the media drive 1610. As these examples illustrate, the storage media 1612 may include a computer-readable storage medium having stored there in particular computer software or data.

In alternative embodiments, the storage devices 1608 may include other similar instrumentalities for allowing computer programs or other instructions or data to be loaded into the computing system 1600. Such instrumentalities may include, for example, a removable storage unit 1614 and a storage unit interface 1616, such as a program cartridge and cartridge interface, a removable memory (for example, a flash memory or other removable memory module) and memory slot, and other removable storage units and interfaces that allow software and data to be transferred from the removable storage unit 1614 to the computing system 1600.

The computing system 1600 may also include a communications interface 1618. The communications interface 1618 may be used to allow software and data to be transferred between the computing system 1600 and external devices. Examples of the communications interface 1618 may include a network interface (such as an Ethernet or other NIC card), a communications port (such as for example, a USB port, a micro USB port), Near field Communication (NFC), etc. Software and data transferred via the communications interface 1618 are in the form of signals which may be electronic, electromagnetic, optical, or other signals capable of being received by the communications interface 1618. These signals are provided to the communications interface 1618 via a channel 1620. The channel 1620 may carry signals and may be implemented using a wireless medium, wire or cable, fiber optics, or other communications medium. Some examples of the channel 1620 may include a phone line, a cellular phone link, an RF link, a Bluetooth link, a network interface, a local or wide area network, and other communications channels.

The computing system 1600 may further include Input/Output (I/O) devices 1622. Examples may include, but are not limited to a display, keypad, microphone, audio speakers, vibrating motor, LED lights, etc. The I/O devices 1622 may receive input from a user and also display an output of the computation performed by the processor 1602. In this document, the terms “computer program product” and “computer-readable medium” may be used generally to refer to media such as, for example, the memory 1606, the storage devices 1608, the removable storage unit 1614, or signal(s) on the channel 1620. These and other forms of computer-readable media may be involved in providing one or more sequences of one or more instructions to the processor 1602 for execution. Such instructions, generally referred to as “computer program code” (which may be grouped in the form of computer programs or other groupings), when executed, enable the computing system 1600 to perform features or functions of embodiments of the present invention.

In an embodiment where the elements are implemented using software, the software may be stored in a computer-readable medium and loaded into the computing system 1600 using, for example, the removable storage unit 1614, the media drive 1610 or the communications interface 1618. The control logic (in this example, software instructions or computer program code), when executed by the processor 1602, causes the processor 1602 to perform the functions of the invention as described herein.

Thus, the present disclosure may overcome drawbacks of traditional systems discussed before. Currently, generation of unfold layouts for ambiguous regions in the B-rep-based CAD sheetmetal models is a manual process. However, the present disclosure generates unfold layouts automatically even for the B-rep-based CAD sheetmetal models which have the ambiguous regions. To generate the unfold layouts, first unfold graphs are generated for the B-rep-based CAD sheetmetal models. A region corresponding to a node which has more than one parent node may be considered as the ambiguous region. Nodes corresponding to the ambiguous regions may be referred to as deform nodes, and unfolding of deform nodes is explained in detail in the disclosure.

Further, the disclosed method and system in the present disclosure may be applicable in various sheetmetal domains where costing needs to be estimated for raw material. By generating the unfold layouts of parts, one can estimate costs for generating the parts. The sheet metal industry produces a wide variety of items, and the complexity of designs is increasing over time. Even with technological advancements, the basic development process remains the same: a layout is cut out of a sheet of metal, and a variety of manufacturing processes are used to create the final product. It is important to generate a layout that can be used to create sheet metal objects. CAD software can be used to design and develop objects of interest, and the algorithms described in the disclosure can be used to unfold the design created in the CAD software and create a flat layout that can be used to draw layouts on the sheet of metal. Thus, the disclosure will not only save time, but can also help to reduce the waste of raw materials.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for identifying an unfold layout for a Boundary Representation (B-rep)-based Computer Aided Design (CAD) sheetmetal model, the method comprising:
validating, by a layout identification device, the B-rep based CAD sheetmetal model when at least one planar face is present in the B-rep based CAD sheetmetal model and thickness of the B-rep based CAD sheetmetal model is within a predefined thickness threshold;
upon successful validation, determining, by the layout identification device, a plurality of nodes corresponding to a plurality of faces of the B-rep based CAD sheetmetal model for generating an unfold graph, wherein the plurality of nodes comprises a root node, one or more plane nodes, one or more cone nodes, and one or more deform nodes, and wherein the root node corresponds to a reference planar face selected from the at least one planar face;
processing, by the layout identification device, the one or more plane nodes and subsequently the one or more cone nodes for generating a first partial unfold layout corresponding to the one or more plane nodes and the one or more cone nodes;
processing, by the layout identification device, the one or more deform nodes for generating a second partial unfold layout corresponding to the one or more deform nodes; and
joining, by the layout identification device, the first partial unfold layout with the second partial unfold layout for generating the unfold layout for the B-rep-based CAD sheetmetal model.

2. The method of claim 1, wherein the plurality of nodes is interconnected through a plurality of links, in the unfold graph, and wherein the plurality of links corresponds to a plurality of edges connecting the plurality of faces in the B-rep-based CAD sheetmetal model.

3. The method of claim 1, further comprising:
determining, by the layout identification device, a presence of at least one planar face in the B-rep based CAD sheetmetal model; and
selecting, by the layout identification device, the reference planar face from the at least one planar face in the B-rep based CAD sheetmetal model.

4. The method of claim 3, further comprising determining, by the layout identification device, the thickness of the B-rep based CAD sheetmetal model based on the reference planar face.

5. The method of claim 1, further comprising:
processing the one or more plane nodes;
determining outer boundaries of one or more planar faces, wherein the one or more planar faces corresponds to the one or more plane nodes; and
applying transformations corresponding to the one or more plane nodes computed during generation of the unfold graph, to the one or more planar faces, wherein the transformations corresponding to the one or more plane nodes are computed based on transformations of corresponding parent nodes.

6. The method of claim 1, further comprising:
processing the one or more cone nodes;
determining uniform points on edges associated with one or more conical faces and cylindrical faces by discretizing the edges based on an internally controlled parameter, wherein the one or more conical faces and cylindrical faces corresponds to the one or more cone nodes;
applying transformations with respect to unfold paths corresponding to the one or more cone nodes computed during generation of the unfold graph, to the uniform points for computing transform points, wherein the transformations corresponding to the cone nodes are computed based on a plurality of predefined parameters of the one or more conical faces and cylindrical faces and transformations of corresponding parent nodes, and wherein the plurality of predefined parameters comprises a bend angle and a radius; and
creating outer boundary curve segments of the one or more conical faces and cylindrical faces based on the transform points.

7. The method of claim 1, wherein generating the second partial unfold layout comprises:
processing the one or more deform nodes;
for each of the one or more deform nodes,
identifying edges of a deform face corresponding to a deform node of the one or more deform nodes;
identifying one or more common edges between the edges of the deform face and edges of adjacent parent faces of the deform face, wherein an unfold path corresponding to the deform face is computed based on the one or more common edges; and
determining presence of curve segments based on unfold layouts created for adjacent faces corresponding to adjacent nodes, wherein the determining the presence comprises:
when the curve segments are present:
creating a copy of the curve segments; and
when the curve segments are absent:
determining uniform points on the edges of the deform face by discretizing edges, based on the internally controlled parameter;
determining the closest points on the one of the edges of the unfold path;
determining a plurality of unfold points corresponding to the closest points based on a proportional relationship between the edges of the deform face and corresponding edges of the edges of adjacent parent faces of the deform face in the first partial unfold layout;
calculating a plurality of transformed unfold points corresponding to the plurality of unfold points based on a translation direction computed for each of the plurality of unfold points, and a length between each of the uniform points on an edge of the deform face and a corresponding closest point on another edge of unfold path of the deform face located at shortest distance;
computing an estimated curve segment through the plurality of transformed unfold points; and
generating the second partial unfold layout using the curve segments.

8. A system for identifying an unfold layout for a Boundary Representation (B-rep)-based Computer Aided Design (CAD) sheetmetal model, the system comprising:
a processor; and
a memory communicatively coupled to the processor, wherein the memory stores processor instructions, which when executed by the processor, cause the processor to:
validate the B-rep based CAD sheetmetal model when at least one planar face is present in the B-rep based CAD sheetmetal model and thickness of the B-rep based CAD sheetmetal model is within a predefined thickness threshold;
upon successful validation, determine a plurality of nodes corresponding to a plurality of faces of the B-rep based CAD sheetmetal model for generating an unfold graph, wherein the plurality of nodes comprises a root node, one or more plane nodes, one or more cone nodes, and one or more deform nodes, and wherein the root node corresponds to a reference planar face selected from the at least one planar face;
process the one or more plane nodes and subsequently the one or more cone nodes for generating a first partial unfold layout corresponding to the one or more plane nodes and the one or more cone nodes;
process the one or more deform nodes for generating a second partial unfold layout corresponding to the one or more deform nodes; and
join the first partial unfold layout with the second partial unfold layout for generating the unfold layout for the B-rep-based CAD sheetmetal model.

9. The system of claim 8, wherein the plurality of nodes is interconnected through a plurality of links, in the unfold graph, and wherein the plurality of links corresponds to a plurality of edges connecting the plurality of faces in the B-rep-based CAD sheetmetal model.

10. The system of claim 8, wherein the processor instructions, on execution, further cause the processor to:
determine a presence of at least one planar face in the B-rep based CAD sheetmetal model; and
selecting the reference planar face from the at least one planar face in the B-rep based CAD sheetmetal model.

11. The system of claim 10, wherein the processor instructions, on execution, further cause the processor to determine thickness of the B-rep based CAD sheetmetal model based on the reference planar face.

12. The system of claim 8, wherein the processor instructions, on execution, further cause the processor to:
process one or more plane nodes;
determine outer boundaries of one or more planar faces, wherein the one or more planar faces corresponds to the one or more plane nodes; and
apply transformations corresponding to the one or more plane nodes computed during generation of the unfold graph, to the one or more planar faces, wherein the transformations corresponding to the one or more plane nodes are computed based on transformations of corresponding parent nodes.

13. The system of claim 8, wherein the processor instructions, on execution, further cause the processor to:
process the one or more cone nodes;
determine uniform points on edges associated with one or more conical faces and cylindrical faces by discretizing the edges, based on an internally controlled parameter, wherein the one or more conical faces and cylindrical faces corresponds to the one or more cone nodes;
apply transformations with respect to unfold paths corresponding to the one or more cone nodes computed during generation of the unfold graph, to the uniform points for computing transform points, wherein the transformations corresponding to the cone nodes are computed based on a plurality of predefined parameters of the one or more conical faces and cylindrical faces and transformations of corresponding parent nodes, and wherein the plurality of predefined parameters comprises a bend angle and a radius; and
create outer boundary curve segments of the one or more conical faces and cylindrical faces based on the transform points.

14. The system of claim 8, wherein the processor instructions, on execution, further cause the processor to generate the second partial unfold layout that comprises:
process one or more deform nodes;
for each of the one or more deform nodes,
identify edges of a deform face corresponding to a deform node of the one or more deform nodes;
identify one or more common edges between the edges of the deform face and edges of adjacent parent faces of the deform face, wherein an unfold path corresponding to the deform face is computed based on the one or more common edges; and
determine presence of curve segments based on unfold layouts created for adjacent faces corresponding to adjacent nodes, wherein determining the presence comprises:
when the curve segments are present:
create a copy of the curve segments; and
when the curve segments are absent:
determine uniform points on the edges of the deform face by discretizing edges, based on the internally controlled parameter;
determine the closest points on the one of the edges of the unfold path;
determine a plurality of unfold points corresponding to the closest points based on a proportional relationship between the edges of the deform face and corresponding edges of the edges of adjacent parent faces of the deform face in the first partial unfold layout;
calculate a plurality of transformed unfold points corresponding to the plurality of unfold points based on a translation direction computed for each of the plurality of unfold points, and a length between each of the uniform points on an edge of the deform face and a corresponding closest point on another edge of unfold path of the deform face located at shortest distance;
compute an estimated curve segment through the plurality of transformed unfold points; and
generate the second partial unfold layout using the curve segments.

15. A non-transitory computer-readable medium storing computer-executable instructions for identifying an unfold layout for a Boundary Representation (B-rep)-based Computer Aided Design (CAD) sheetmetal model, the computer-executable instructions configured for:
validating the B-rep based CAD sheetmetal model when at least one planar face is present in the B-rep based CAD sheetmetal model and thickness of the B-rep based CAD sheetmetal model is within a predefined thickness threshold;
upon successful validation, determining a plurality of nodes corresponding to a plurality of faces of the B-rep based CAD sheetmetal model for generating an unfold graph, wherein the plurality of nodes comprises a root node, one or more plane nodes, one or more cone nodes, and one or more deform nodes, and wherein the root node corresponds to a reference planar face selected from the at least one planar face;
processing the one or more plane nodes and subsequently the one or more cone nodes for generating a first partial unfold layout corresponding to the one or more plane nodes and the one or more cone nodes;
processing the one or more deform nodes for generating a second partial unfold layout corresponding to the one or more deform nodes; and
joining the first partial unfold layout with the second partial unfold layout for generating the unfold layout for the B-rep-based CAD sheetmetal model.

16. The non-transitory computer-readable medium of the claim 15, wherein the plurality of nodes is interconnected through a plurality of links, in the unfold graph, and wherein the plurality of links corresponds to a plurality of edges connecting the plurality of faces in the B-rep-based CAD sheetmetal model.

17. The non-transitory computer-readable medium of the claim 15, wherein the computer-executable instructions further configured for:
determining a presence of at least one planar face in the B-rep based CAD sheetmetal model; and
selecting the reference planar face from the at least one planar face in the B-rep based CAD sheetmetal model.

18. The non-transitory computer-readable medium of the claim 17, wherein the computer-executable instructions further configured for determining thickness of the B-rep based CAD sheetmetal model based on the reference planar face.

19. The non-transitory computer-readable medium of the claim 15, wherein the computer-executable instructions further configured for:
processing the one or more plane nodes;
determining outer boundaries of one or more planar faces, wherein the one or more planar faces corresponds to the one or more plane nodes; and
applying transformations corresponding to the one or more plane nodes computed during generation of the unfold graph, to the one or more planar faces, wherein the transformations corresponding to the one or more plane nodes are computed based on transformations of corresponding parent nodes.

20. The non-transitory computer-readable medium of the claim 15, wherein the computer-executable instructions further configured for:
processing the one or more cone nodes;
determining uniform points on edges associated with one or more conical faces and cylindrical faces by discretizing the edges, based on an internally controlled parameter, wherein the one or more conical faces and cylindrical faces corresponds to the one or more cone nodes;
applying transformations with respect to unfold paths corresponding to the one or more cone nodes computed during generation of the unfold graph, to the uniform points for computing transform points, wherein the transformations corresponding to the cone nodes are computed based on a plurality of predefined parameters of the one or more conical faces and cylindrical faces and transformations of corresponding parent nodes, and wherein the plurality of parameters comprises a bend angle and a radius; and
creating outer boundary curve segments of the one or more conical faces and cylindrical faces based on the transform points.
